(19) United States
(12) Patent Application Publication
(10) Pub. No.: US 2026/0222812 A1
(43) Pub. Date: Jul. 30, 2026

(54) DEVICE AND METHOD FOR MANAGING INFORMATION IN A WIRELESS COMMUNICATION

(71) Applicant: SAMSUNG ELECTRONICS CO., LTD., Gyeonggi-do (KR)

(72) Inventors: Rajavelsamy RAJADURAI, Bangalore (IN); Nivedya Parambath SASI, Bangalore (IN); Rohini RAJENDRAN, Bangalore (IN)

(21) Appl. No.: 19/144,706

(22) PCT Filed: Jan. 5, 2024
(86) PCT No.: PCT/KR2024/000286

§ 371 Date: Jun. 30, 2025

(30) Foreign Application Priority Data
Jan. 7, 2023 (IN) 202341001446
Dec. 26, 2023 (IN) 202341001446

(51) Int. Cl. H04W 12/069; H04W 12/00; H04W 80/06

(52) U.S. Cl. CPC H04W 12/069; H04W 12/009; H04W 80/06

(57) ABSTRACT

The disclosure relates to a 5G or 6G communication system for supporting a higher data transmission rate. Embodiments herein disclose an Edge computing module not sharing User Equipment (UE) sensitive information, if only server side authentication has been performed. Embodiments herein disclose methods and systems to expose and/or provide the network security capability (supports AKMA or not) to the UE and/or Application Function (AF). Embodiments herein disclose methods and systems to provision the UE With the public key of the Application Function (ECS, EES, EAS, like so) to the UE, When the system uses RaW Public Key in Transport Layer Security (TLS) as the default authentication method. Embodiments herein disclose methods and systems to restrict the UE sensitive information to be shared with an unauthenticated EEC and/or UE.

### TECHNICAL FIELD

Embodiments disclosed herein relate to wireless communication networks, and more particularly to managing and exposing the Authentication and key management for applications (AKMA) security capability of network.

### BACKGROUND ART

5G mobile communication technologies define broad frequency bands such that high transmission rates and new services are possible, and can be implemented not only in “Sub 6 GHz” bands such as 3.5GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface/chitecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

FIG. 1 depicts a fundamental network model of AKMA, as well as the interfaces between them. 3GPP introduced a new security feature and mechanism to support authentication and key management aspects for applications (AKMA) based on 3rd Generation Partnership Project (3GPP) subscription credential(s) in 5G system as defined in TS 33.501. AKMA reuses the 5G primary authentication procedure executed, for example, during the User Equipment (UE) Registration to authenticate the UE. A successful 5G primary authentication results in KAUSF being stored at the AUSF and the UE.

FIG. 2 depicts the process of deriving the AKMA key, KAKMA and AKMA key ID (A-KID) after primary authentication. Before communication between the UE and the Application Function (AF) can start, the UE and the AF need to know whether to use AKMA. This knowledge is implicit to the specific application on the UE and the AF or indicated by the AF to the UE.

When the AF receives the application session establishment request from the UE with AKMA parameters, the AF contacts the AKMA Anchor Function (AAnF) to get the application specific keys. If the PLMN supports AKMA, the AAnF is discovered and selected. In the case of NF consumer-based discovery and selection, the following applies:
Internal AFs and the Network Exposure Function (NEF) performs AAnF instance selection that handles the AKMA request. The AF/NEF shall utilize the NRF to discover the AAnF instance(s), unless AAnF information is available by other means; for example, locally configured on the AF/NEF.
The AUSF performs AAnF selection to allocate an AAnF Instance to send the AKMA key material related to the UE. The AUSF shall utilize the NRF to discover the AAnF instance(s) unless AAnF information is available by other means; for example, locally configured on the AUSF.
The NF specified in TS 33.501, performs AAnF instance selection that handles the AKMA request. The NF shall utilize the NRF to discover the AAnF instance(s) unless AAnF information is available by other means; for example, locally configured on the NF.

The AAnF selection functionality in NF consumer or in Service Communication Proxy (SCP) can consider the UE's Routing Indicator. Internal AFs, the NEF and the AUSF shall select the same AAnF set based on the UE's Routing Indicator.

When the UE's Routing Indicator is set to its default value, the AAnF NF consumer can select any AAnF instance within the home network of the UE. In scenarios, where multiple sets of AAnFs are deployed, it is left up to implementation how to ensure that the AAnF NF consumers select an AAnF instance within the AAnF set the UE belongs to when the UE's Routing Indicator is set to its default value.

AKMA is widely being used in various use cases; for example, ProSe, EDGE, MBS, and so on. A 3GPP study for EDGE security enhancement, TR 33.739 relies on the knowledge of the security capability (in other words, supported security service or authentication method like AKMA, Generic Bootstrapping Architecture (GBA), Open Authorization (OAUTH), Certificate based Authentication method, Raw Public Key based authentication methods) of the Home Network, Serving Network, UE capability and EDN capability, however there is no method defined on how the UE or the AF is aware if the Network supports a security capability/service/authentication method. Without either UE and/or AF knowing network capability, the UE should not derive the AKMA keys or even if UE derives and requests the AF for service, the AAnF discovery and selection will fail as there is no AAnF deployed (HN does not have AKMA capability) and/or the AF is not locally configured with AAnF discovery or selection information.

In 3GPP SA 3 , it was decided to consider server side certificate as mandatory to be supported in case if there is no common mutual authentication method selected.

Further from TS 33.558, it is clear that the ECS provides token, which will include EEC ID, GPSI, expected service name, like so which are UE specific information. Hence, sending these UE specific information will lead to privacy issues and also allows unauthorized access, if client is not authenticated.

TS 23.558 specifies the procedures, information flows and APIs for service provisioning in which security credentials are shared to the EEC as part of service provisioning response. Hence, sending security credentials to an unauthenticated and unauthorized client leads to security risksBased on the security requirements from TS 23.558, it is clear that both client and server needs to be mutually authenticated. However, as EEC and ECS and/or EES can opt for only server-side certificate based authentication it is required to evaluate the information shared to the EEC by the ECS and EES. If there is no EEC/UE side authentication performed and only Server side certificate-based TLS authentication is performed, then the privileged services, subscribe service and UE specific information (specifically access token) are not provided by the ECS/EES to the UE.

Hence, there is a need in the art for solutions which will overcome the above mentioned drawback(s), among others.

The principal object of the embodiments herein is to disclose an Edge computing module not sharing User Equipment (UE) sensitive information, if only server side authentication has been performed.

Another objective of the embodiments herein is to disclose methods and systems to expose and/or provide the network security capability (supports AKMA or not) to the UE and/or Application Function (AF).

Another objective of the embodiments herein is to disclose methods and systems to provision the UE with the public key of the Application Function (ECS, EES, EAS, like so) to the UE, when the system uses Raw Public Key in Transport Layer Security (TLS) as the default authentication method.

Another objective of the embodiments herein is to disclose methods and systems to restrict the UE sensitive information to be shared with an unauthenticated EEC and/or UE.

### DISCLOSURE OF INVENTION

### Solution to Problem

Accordingly, the embodiments herein provide a method for managing sensitive information of a User Equipment (UE). The method comprises attempting, by an edge computing module, to perform mutual authentication with the UE; and not sending, by the edge computing module, User Equipment (UE) specific sensitive information and services to the UE, if the server side authentication has been successfully performed, and the UE side authentication has not been performed.

Accordingly, the embodiments herein provide an edge computing module comprising a memory; and a processor. the processor is coupled to the memory and configured to attempt to perform server side authentication with a User Equipment (UE); and not send UE specific sensitive information and services to the UE, if the server side authentication has been successfully performed, and the UE side authentication has not been performed.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a fundamental network model of AKMA, as well as the interfaces between them;

FIG. 2 depicts the process of deriving KAKMA after primary authentication, according to existing arts;

FIGS. 3A and 3B depict a wireless communication network, according to embodiments as disclosed herein;

FIG. 4 depicts a wireless communication network configured to authenticate the UE, according to embodiments as disclosed herein;

FIG. 5 is a flowchart depicting the process of managing UE sensitive information in a wireless communication network, according to embodiments as disclosed herein;

FIG. 6 depicts the process of indicating HN AKMA capability, according to embodiments as disclosed herein; and

FIGS. 7A and 7B depict the process of exposing network AKMA capability, according to embodiments as disclosed herein.

FIG. 8 illustrates a UE according to embodiments as disclosed herein.

FIG. 9 illustrates a network entity according to embodiments as disclosed herein.

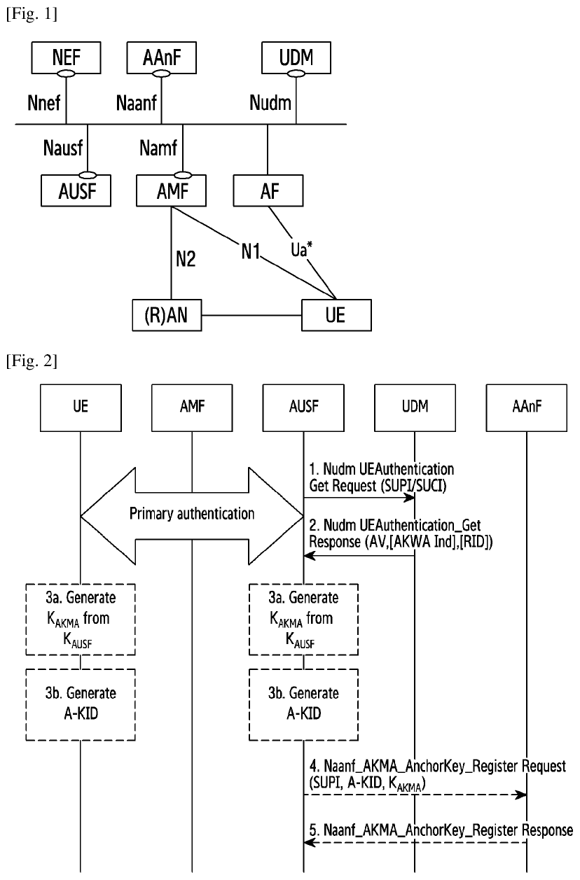

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### Mode for the Invention

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

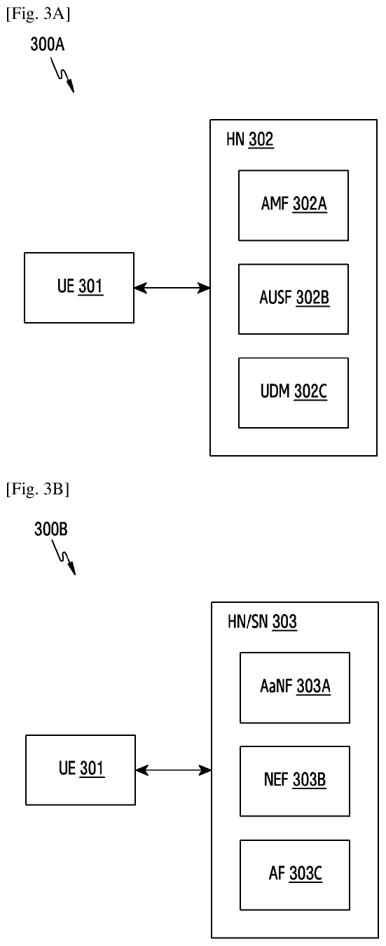

The embodiments herein achieve methods and systems to expose and/or provide the network security capability (supports AKMA or not) to the UE and/or Application Function (AF). Referring now to the drawings, and more particularly to FIGS. 3A through 7B, where similar reference characters denote corresponding features consistently throughout the figures, there are shown embodiments.

The term “Home Network (HN)” refers to a network where the UE holds the subscription (home network). The term “Serving network (SN) refers to a network which provides service(s) to the UE. An SN (which may or may not be the home network) that is authorized by the home network to provide service(s) to the UE.

The terms “network”, “PLMN”, “Core Network (CN)” is used interchangeably throughout this document and refers to the HN and/or SN.

FIGS. 3A and 3B depict a wireless communication network. The wireless communication network 300A, as depicted, comprises a User Equipment (UE) 301, and a Home Network (HN) 302 (as depicted in FIG. 3A). The HN 302 comprises an Access and Mobility Management Function (AMF) 302A, an Authentication Server Function (AUSF) 302B, and a Unified Data Management (UDM) 302C.

In various embodiments herein, the UE 301 can preconfigure a Universal Integrated Circuit Card (UICC) (present in the UE 301) with the Home network AKMA capability indication. When the Home network AKMA capability indication is available, the UE 301 can generate the AKMA keys and A-KID from KAUSF after successful primary authentication (generation of AKMA keys and A-KID from KAUSF are specified in TS 33.535) or whenever requested by the upper layers (applications in the Application layer). In various embodiments herein, the contents of files in the UICC can be at the DF5GS level which includes service n‘xxx which states the support for AKMA in the HN 302.

In various embodiments herein, the UE 301 can receive HN AKMA capability indication during an UE parameter update procedure as part of content of UE Parameters Update Data, if the HN 302 supports AKMA.

The wireless communication network 300B, as depicted, comprises a User Equipment (UE) 301, and a HN/SN 303 (as depicted in FIG. 3B). The HN/SN 303 comprises an AKMA Anchor Function (AAnF) 303A, a Network Exposure Function (NEF) 303B, and an Application Function (AF) 303C.

In various embodiments herein, the NEF 303B can expose the network application capability. The UE 301 queries the NEF 303B of the HN/SN 303, to know the network security capability.

In various embodiments herein, the network capability can be included in the NAS message. In various embodiments, the HN/SN 303 can provide the security capabilities in NAS message to the UE 301 during NAS procedure. Examples of the NAS procedure can be, but not limited to, Authentication, Registration, UL/DL NAS Transport, De-Registration, Service Setup, Configuration Update, Identify Query Notification, Security Mode Setup, and 5G Mobility Management (5GMM) Status.

FIG. 4 depicts a wireless communication network configured to authenticate the UE. The wireless communication network 400, as depicted, comprises a UE 301, and at least one edge computing module 401. The edge computing module 401, as depicted, can comprise a processor 401A, a memory 401B, a communicator module 401C. The edge computing module 401 can be configured to authenticate the UE 301. In various embodiments herein, the edge computing module 401 can be at least one of an Edge Configuration Server (ECS), and an Edge Enabler Server (EES).

The processor 401A can attempt to perform server side and UE side (also referred to herein as client side) authentication with the UE 301. In various embodiments herein, the server side authentication as referred to herein can be a server certificate based Transport Layer Security (TLS) certificate. In various embodiments herein, consider that the server side authentication has been completed successfully, and the UE side authentication is unable to be performed or unable to be completed successfully. In an example herein, the UE side authentication is not performed or not completed successfully, if the edge computing module 401, and the UE 301 are unable to select a common authentication method. In an example herein, the UE side authentication is not performed or not completed successfully, if a selected common authentication method (between the UE 301, and the edge computing module 401) is not supported at the UE 301.

On determining that the that the server side authentication has been completed successfully, and the UE side authentication is unable to be performed or unable to be completed successfully, the processor 401A does not send UE specific sensitive information and services to the UE. Examples of the UE specific sensitive information and services can be, but not limited to, privileged services, subscribe services, an access token, UE identifier and location information.

On determining that the server side authentication has been completed successfully, and the UE side authentication is unable to be performed or unable to be completed successfully, the processor 401A can send generic information to the UE 301.

The processor 401A can be implemented by analog and/or digital circuits such as logic gates, integrated circuits, microprocessors, microcontrollers, memory circuits, passive electronic components, active electronic components, optical components, hardwired circuits, and the like, and may optionally be driven by firmware.

The processor 401A may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 401A may include multiple cores and is configured to execute the instructions stored in the memory 401C.

Further, the processor 401A can be configured to execute instructions stored in the memory 401C and to perform various processes. The communicator module 401C can be configured for communicating internally between internal hardware components and with external devices via one or more networks. The memory 401C also stores instructions to be executed by the processor (110). The memory 401C may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 401C may, in some examples, be considered a non-transitory storage medium. The term “non-transitory” may indicate that the storage medium is not embodied in a carrier wave or a propagated signal. However, the term “non-transitory” should not be interpreted that the memory 401C is non-movable. In certain examples, a non-transitory storage medium may store data that can, over time, change (e.g., in Random Access Memory (RAM) or cache).

In various embodiments, the communicator module 401C includes an electronic circuit specific to a standard that enables wired or wireless communication. The communicator module 401C is configured to communicate internally between internal hardware components of the edge computing module 401 and with external devices via one or more networks.

Although the FIG. 4 shows various hardware components of the edge computing module 401, but it is to be understood that other embodiments are not limited thereon. In other embodiments, the edge computing module 401 may include less or more number of components. Further, the labels or names of the components are used only for illustrative purposes, and does not limit the scope of the disclosure. One or more components can be combined together to perform same or substantially similar function in the edge computing module 401.

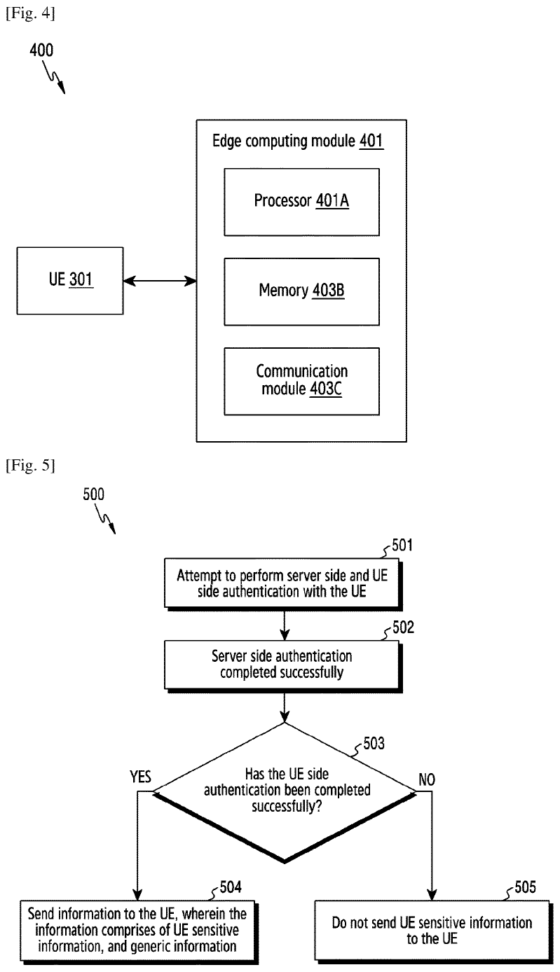

FIG. 5 is a flowchart depicting the process of managing UE sensitive information in a wireless communication network. In step 501, the edge computing module 401 attempts to perform server side and UE side authentication with the UE 301. In various embodiments herein, the server side authentication as referred to herein can be a server certificate based Transport Layer Security (TLS) certificate. In step 502, the UE 301 and the edge computing module 401 successfully complete the server side authentication. In step 503, the edge computing module 401 checks if the UE side authentication has been completed successfully. If the UE side authentication has been completed successfully, in step 504, the edge computing module 401 sends information to the UE 301, wherein the information comprises of UE sensitive information, and generic information. If the UE side authentication is unable to be performed or unable to be completed successfully, in step 504, the edge computing module 401 does not send UE sensitive information to the UE 301. Examples of the UE specific sensitive information and services can be, but not limited to, privileged services, subscribe services, an access token, UE identifier and location information. In various embodiments herein, the edge computing module 401 can send only the generic information to the UE 301. The various actions in method 500 may be performed in the order presented, in a different order or simultaneously. Further, in some embodiments, some actions listed in FIG. 5 may be omitted.

### UE Determining the Support for AKMA in Home Network:

In various embodiments herein, the UICC can be (pre)configured with the Home network AKMA capability indication. When the Home network AKMA capability indication is available, the UE 301 can generate the AKMA keys and A-KID from KAUSF after successful primary authentication (generation of AKMA keys and A-KID from KAUSF are specified in TS 33.535) or whenever requested by the upper layers (applications in the Application layer). In various embodiments, the contents of files in the UICC is at the DF5GS level, includes service n‘xxx which states the support for AKMA in the Home network 302.

In various embodiments herein, the UE 301 can receive the HN AKMA capability indication during the UE parameter update procedure as part of content of UE Parameters Update Data, if the Home Network 302 of the UE 301 supports AKMA.

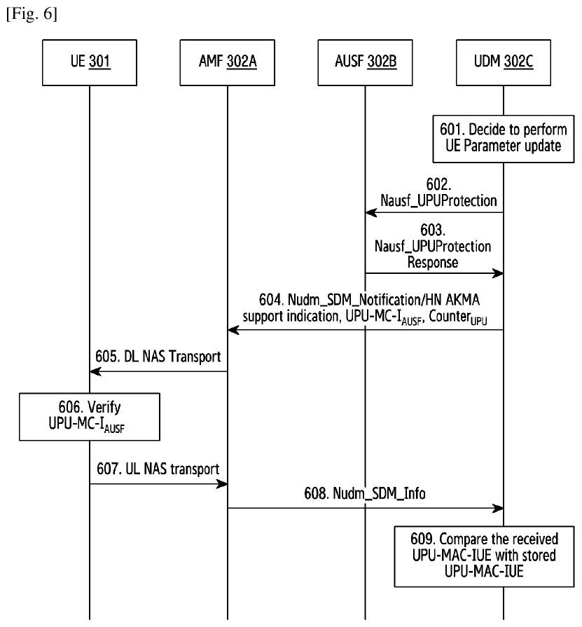

FIG. 6 depicts the process of indicating HN AKMA capability. In step 601, the UDM 302C decides to perform the UE Parameters Update (UPU) using the control plane procedure, while the UE 301 is registered to the 5G system. The UDM 302C prepares the UE Parameters Update Data (UPU Data) by including the parameters protected by the secured packet, if any, as well as any UE parameters for which final consumer is the ME. The UDM 302C further includes the HN AKMA support indication in the UPU data, if the HN 302 supports AKMA service. In steps 602 & 603, the UDM 302C shall invoke Nausf_UPUProtection service operation message by including the UPU Data (HN AKMA support indication) to the AUSF 302B. The UDM 302C shall select the AUSF 302B that holds the latest KAUSF of the UE 301. In step 604, the UDM 302C shall invoke Nudm_SDM_Notification service operation, which includes the UPU transparent container, if the AMF 302A supports UPU transparent container, or includes individual IEs comprising the UE Parameters Update Data, HN AKMA support indication (if supported), UPU-MAC-IAUSF, CounterUPU within the Access and Mobility Subscription data. If the UDM 302C requests an acknowledgement, it shall temporarily store the expected UPU-XMAC-IUE. In step 605, upon receiving the Nudm_SDM_Notification message, the AMF 302A shall send a DL NAS Transport message to the served UE 301. The AMF 302A shall include in the DL NAS Transport message, the transparent container if received from the UDM in step 604. Otherwise, if the UDM provided individual IEs in step 4, then the AMF 302A constructs a UPU transparent container. In steps 606, 607, and 608, and 609, on receiving the DL NAS Transport message, the UE 301 proceeds with the UPU procedure as specified in 3GPP TS 33.501. The UE 301 stores the HN AKMA support indication (if available) to determine the support of AKMA by the HN. If the indication is not included by the network in the UPU procedure, then the UE 301 determines no support for AKMA in the Home Network 302, if there is no indication in the UE 301 by other means (like configuration in the UICC).

AF determines the support for AKMA in HN and/or SN:

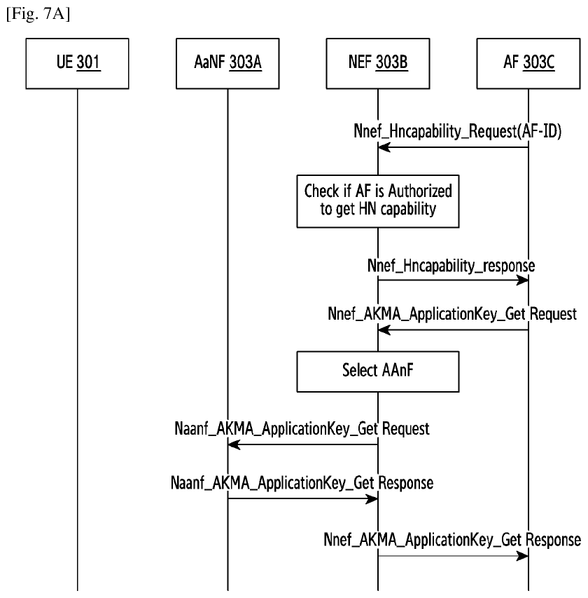

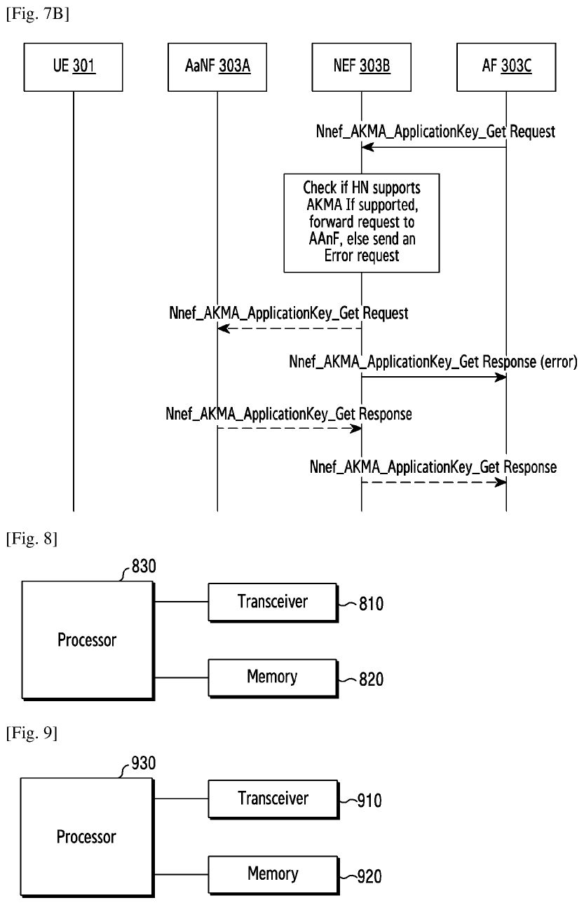

FIGS. 7A and 7B depict the process of exposing network AKMA capability. In various embodiments herein, the AF 303C uses a new service operation such as Nnef_CNSeccapability_request message with the AF ID to enquire on the CN support of security capabilities. Examples of security capabilities can be, but not limited to, security service or authentication method: AKMA, GBA, OAuth, Client-Server certificate, server-side certificate, RAW public key like so on. The NEF checks if the AF is authorized to get the CN capability as part of the NEF-AF mutual authentication and authorization. If the AF is authorized, the NEF 303B responds in Nnef_CNSeccapability response message with CN supported security capabilities. The NEF 303B stores/retrieves the security capability (supported security service/authentication methods) information as structured data using a standardized interface (Nudr) to the Unified Data Repository (UDR). For example, if the network supports AKMA, then the response includes AKMA support indication. Based on the response, the AF 303C determines the security capabilities of the network and proceeds further; for example, the AF 303C further proceeds with the AKMA key request procedure (as specified in TS 33.535), if the network indicated AKMA support and AF selected AKMA to establish Pre Shared Key (PSK) for secure establishment of TLS tunnel with the UE 301.

In various embodiments, if the AF 303C and/or the UE 301 determines server-side certificate based authentication method (based on the response from the NEF 303B, and/or configuration that do not support AKMA, GBA, client-side certificate) and performs server-side certificate based authentication method for establishment of TLS tunnel, then the UE 301 can be provided with the no privileged services (or provided with generic information and not provided with UE specific information); i.e., the AF 303C and/or the network 303 is not allowed to expose any UE specific sensitive information for example, UE ID, location information like so, as this may lead to privacy issue as there is no client side authentication performed.

In various embodiments, the AF 303C uses a new service operation to check the support for each security service (such as Nnef_CNSeccapability_AKMA_request message) with the AF ID to enquire on the CN support of AKMA. The AF 303C uses Nnef_CNSeccapability_GBA_request to enquire on the Core Network (CN) support of GBA. The NEF 303B checks if the AF 303C is authorized to get the CN capability as part of the NEF-AF mutual authentication and authorization. If the AF 303C is authorized, the NEF 303B responds in response message whether CN support the security capability. For example, if the request is Nnef_CNSeccapability_AKMA_request message, then the response includes AKMA is supported or not supported indication.

In another embodiment, the AF 303C uses the existing service operation such as Nnef_AKMA_ApplicationKey_Get request message to enquire on the HN support of AKMA. The NEF 303B checks if the network 303 supports AKMA. If the network 303 supports AKMA, then the NEF 303B further proceeds with the key request procedure (as specified in TS 33.535). If the network 303 does not support AKMA, then the AF 303C is responded with an error message in Nnef_AKMA_ApplicationKey_Get response message with the error cause stating “no AAnF found”/“no AKMA capability”/“service unrecognised”

In various embodiments, the UE 301 is provided with the public key of the AF by the network 303. The public key is provisioned as a parameter in the ECS configuration information. For example, in case of EDGE, using the at least one of the following procedure: during initial provisioning, during service provisioning, EES Registration, and during the EAS registration procedure, as part of EES profile, EEC registration configuration, EDN configuration information, EES registration procedure, and so on.

In various embodiments, the network 303 provides/provisions the public key to the UICC and an Edge Enabler Client (EEC) (i.e., the UE 301) fetches the information from the UICC.

Embodiments herein resolve the security issue of sharing UE sensitive information of the unauthenticated EEC/UE by the edge computing module, which can lead to privacy issues and also allows unauthorized access.

The embodiments disclosed herein can be implemented through at least one software program running on at least one hardware device and performing network management functions to control the network elements. The elements include blocks which can be at least one of a hardware device, or a combination of hardware device and software module.

The embodiment disclosed herein describes methods and systems to expose and/or provide the network security capability (supports AKMA or not) to the UE and/or Application Function (AF). Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

FIG. 8 illustrates a structure of a UE according to an embodiment of the disclosure.

As shown in FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor. Furthermore, the UE of FIG. 8 corresponds to the UE or the edge computing module of FIG. 4.

The transceiver 810 collectively refers to a UE receiver and a UE transmitter, and may transmit/receive a signal to/from a base station or a network entity. The signal transmitted or received to or from the base station or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

FIG. 9 illustrates a structure of a network entity according to an embodiment of the disclosure.

As shown in FIG. 9, the network entity according to an embodiment may include a transceiver 910, a memory 920, and a processor 930. The transceiver 910, the memory 920, and the processor 930 of the network entity may operate according to a communication method of the network entity described above. However, the components of the network entity are not limited thereto. For example, the network entity may include more or fewer components than those described above. In addition, the processor 930, the transceiver 910, and the memory 920 may be implemented as a single chip. Also, the processor 930 may include at least one processor. Furthermore, the network entity of FIG. 9 corresponds to the network entity of other figures.

The transceiver 910 collectively refers to a network entity receiver and a network entity transmitter, and may transmit/receive a signal to/from a terminal (UE) or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the network entity. Also, the memory 920 may store control information or data included in a signal obtained by the network entity. The memory 920 may be a storage medium, such as read-only memory (ROM), random access memory (RAM), a hard disk, a CD-ROM, and a DVD, or a combination of storage media.

The processor 930 may control a series of processes such that the network entity operates as described above. For example, the transceiver 910 may receive a data signal including a control signal transmitted by the terminal, and the processor 930 may determine a result of receiving the control signal and the data signal transmitted by the terminal.

The processor disclosed herein may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In various embodiments, a method for managing sensitive information of a User Equipment (UE), the method comprising: attempting, by an edge computing module, to perform server side authentication with the UE; and not sending, by the edge computing module, User Equipment (UE) specific sensitive information and services to the UE, if the server side authentication has been successfully performed, and the UE side authentication has not been performed.

Preferably, the edge computing module is at least one of an Edge Configuration Server (ECS), and an Edge Enabler Server (EES).

Preferably, the server side authentication is a server certificate based Transport Layer Security (TLS) certificate.

Preferably, the UE authentication is not performed, if the edge computing module, and the UE are unable to select a common authentication method.

Preferably, the UE authentication is not performed, if a selected common authentication method is not supported at the UE.

Preferably, the UE specific sensitive information and services comprises privileged services, subscribe services, an access token, UE identifier and location information.

Preferably, the method comprises sending, by the edge computing module, generic information to the UE, if the server side authentication has been successfully performed, and the UE side authentication has not been performed.

In various embodiments, an edge computing module comprising: a memory; and a processor; wherein the processor is coupled to the memory and configured to: attempt to perform server side authentication with a User Equipment (UE); and not send UE specific sensitive information and services to the UE, if the server side authentication has been successfully performed, and the UE side authentication has not been performed.

Preferably, the edge computing module is at least one of an Edge Configuration Server (ECS), and an Edge Enabler Server (EES).

Preferably, the server side authentication is a server certificate based Transport Layer Security (TLS) certificate.

Preferably, the edge computing module is configured to provide generic information to the UE, if the server side authentication has been successfully performed, and the UE side authentication has not been performed.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1. A method performed by an edge configuration server (ECS) in a wireless communication system, the method comprising:
performing a server side certificate-based transport layer security (TLS) authentication;
identifying whether a user equipment (UE) side authentication has been completed; and
transmitting, to the UE, information on at least one service based on the identifying whether the UE side authentication has been completed.

2. The method of claim 1,
wherein, in case that the UE side authentication has been completed, the information includes UE specific information and the at least one service includes a privileged service.

3. The method of claim 1,
wherein, in case that the UE side authentication has not been completed, the information includes generic information.

4. The method of claim 2,
wherein the UE specific information includes at least one of a UE identifier and a UE location.

5. An edge configuration server (ECS) in a wireless communication system, the ECS comprising:
a transceiver; and
at least one processor coupled with the transceiver and configured to:
perform a server side certificate-based transport layer security (TLS) authentication;
identify whether a user equipment (UE) side authentication has been completed; and
transmit, to the UE, information on at least one service based on the identifying whether the UE side authentication has been completed.

6. The ECS of claim 5,
wherein, in case that the UE side authentication has been completed, the information includes UE specific information and the at least one service includes a privileged service.

7. The ECS of claim 5,
wherein, in case that the UE side authentication has not been completed, the information includes generic information.

8. The ECS of claim 6,
wherein the UE specific information includes at least one of a UE identifier and a UE location.

9. A method performed by a user equipment (UE), the method comprising:
performing a server side certificate-based transport layer security (TLS) authentication; and
receiving, from an edge configuration server (ECS), information on at least one service based on whether the UE side authentication has been completed.

10. The method of claim 9,
wherein, in case that the UE side authentication has been completed, the information includes UE specific information and the at least one service includes a privileged service.

11. The method of claim 9,
wherein, in case that the UE side authentication has not been completed, the information includes generic information.

12. The method of claim 10,
wherein the UE specific information includes at least one of a UE identifier and a UE location.

13. A user equipment (UE) in a wireless communication system, the UE comprising:
a transceiver;
at least one processor coupled with the transceiver and configured to:
perform a server side certificate-based transport layer security (TLS) authentication; and
receive, from an edge configuration server (ECS), information on at least one service based on whether the UE side authentication has been completed.

14. The UE of claim 13,
wherein, in case that the UE side authentication has been completed, the information includes UE specific information and the at least one service includes a privileged service.

15. The UE of claim 13,
wherein, in case that the UE side authentication has not been completed, the information includes generic information.
